(19) United States
(12) Patent Application Publication
(10) Pub. No.: US 2017/0177929 A1
(43) Pub. Date: Jun. 22, 2017

(54) CROWD GESTURE RECOGNITION

(71) Applicant: Intel Corporation, Santa Clara, CA (US)

(72) Inventors: Stephanie Moyerman, Phoenix, AZ (US); Tyler Fetters, Hillsboro, OR (US); Lakshman Krishnamurthy, Portland, OR (US); James Brian Hall, Tucson, AZ (US)

(21) Appl. No.: 14/976,548

(22) Filed: Dec. 21, 2015

(51) Int. Cl. G06K 9/00; G01P 13/00

(52) U.S. Cl. CPC G06K 9/00335; G01P 13/00

(57) ABSTRACT

Various systems and methods for implementing crowd gesture recognition are described herein. A system for implementing crowd gesture recognition includes an accelerometer; a gyrometer; a gesture detection circuit to: detect an air gesture performed by a user of the system based on data from the accelerometer and gyrometer; and parameterize an intensity of the air gesture; a processor subsystem to determine a transmission frequency band and a transmission strength based on the air gesture and the intensity of the air gesture; and a transducer to transmit a signal on the transmission frequency band with the transmission strength.

### TECHNICAL FIELD

Embodiments described herein generally relate to wireless communication and in particular, to crowd gesture recognition.

### BACKGROUND

At various types of gatherings, such as sporting events or political rallies, event producers attempt to quantify crowd involvement or crowd sentiment.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an environment where users are interacting with the environment using wearable devices, according to an embodiment;

FIG. 2 is a block diagram illustrating a gesture capture device and a base station, according to an embodiment;

FIG. 3 is a block diagram of an example of a gesture capture device upon which one or more embodiments may be implemented;

FIG. 4 is block diagram illustrating another gesture capture device and a camera array, according to an embodiment;

FIG. 5 is a block diagram illustrating system for implementing crowd gesture recognition, according to an embodiment;

FIG. 6 is a flowchart illustrating a method of implementing crowd gesture recognition, according to an embodiment; and

FIG. 7 is a block diagram illustrating an example machine upon which any one or more of the techniques (e.g., methodologies) discussed herein may perform, according to an example embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

An audience response system may be used to capture votes or other responses. Conventional audience response systems (ARSs) include using a handheld device by members of an audience to cast votes or responses to prompts. The handheld device may be a mobile phone and the response may be provided by text service, a lightweight app executing on the mobile phone, or other client user interface that transmits an audience member's response to a backend server. The backend server may then aggregate the information and provide results to an analyst, event producer, pollster, or other person interested in the results.

Use of an interactive device may distract the audience member from the presentation. Additionally, the interactive device may need setup (e.g., install an application) or certain backend setup and maintenance, which may be expensive to install or cumbersome to use. Also, using a client-server model requires particular networking protocols to be established (e.g., Wi-Fi or Short Message Service, etc.), which increases the overhead. Finally, the interactive ASRs may limit the real-time interaction between the audience and the performers because of the data aggregation and analysis used in the client-server model. What is needed is a more intuitive, natural, and engaging mechanism to allow audiences to react to a performance without distraction and use their natural responses during the performance.

Systems and methods described herein implement crowd gesture recognition. Using gestures instead of an interactive model, allows users to forget about how to interact, and just respond naturally while enjoying the performance. For example, at a sporting event, instead of having to look down at a smartphone to vote whether an umpire made a good or bad call, the audience member may be equipped with a smart bracelet that captures the member's arm motions (or lack of motion). As such, when the member is excited and happy about a call and raises his hands over his head, the responsive gesture is captured and accounted for. When the member is upset and does not move much, a non-movement gesture may be identified and accounted for. Based on the overall audience response, the sportscasters may report on how many users within the audience thought the call was good or bad.

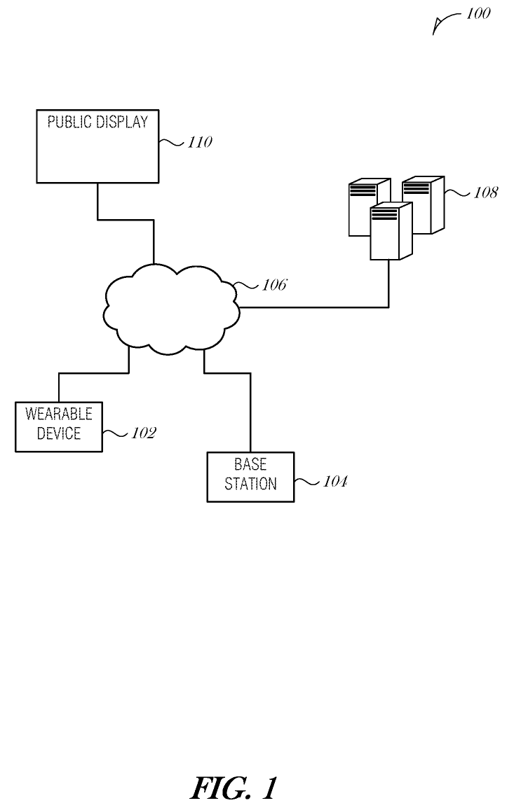

FIG. 1 is a diagram illustrating an environment 100 where users are interacting with the environment 100 using wearable devices 102, according to an embodiment. The environment 100 includes one or more wearable devices 102, with each wearable device 102 arranged to communicate to one or more base stations 104 over a transmission medium 106. The wearable devices 102 include devices capable of capturing and recognizing arm, hand, or finger gestures. In embodiments, the wearable device 102 is a smartwatch, a smart bracelet, a smart ring, a smart glove, or the like. The wearable device 102 may be equipped with various sensors, transducers, radios, and other circuitry to provide geolocation (e.g., GPS), detect acceleration (e.g., an accelerometer or a gyrometer), detect orientation (e.g., a magnetometer), etc. Some of the circuitry may be combined into a single die or integrated circuit, such as with an inertial navigation unit (INU) or an inertial measurement unit (IMU). In other embodiments, the wearable device 102 may be a mobile device which the user carries in a pocket such as a smartphone, pager, or the like.

Although FIG. 1 illustrates that the wearable device 102 is used to capture the user's gesture, it is understood that other mechanisms or devices may be used. For example, a user may wave a mobile device, such as a smartphone, in free space as a gesture. As another example, a camera array may capture the user's movements and translate them to a gesture. As another example, a mobile device, such as a smartphone, may be stored in a user's pocket. The user's movements (e.g., jumping up and down in excitement) may be translated to the mobile device and captured as the user's gesture.

As a user moves, the wearable device 102 captures a gesture, classifies it, and then based on the classification, transmits a signal to the base station 104 at a certain radio frequency band. In some examples, the wearable device 102 transmits a raw radio signal, such as a pure tone, to the base station 104. In such an example, the wearable device 102 does not need to adhere to any specific communication protocol, but rather just transmits any arbitrary signal at a certain frequency band. In other examples, the wearable device 102 transmits the signal as a packet over a particular network protocol (e.g., Wi-Fi). In these such examples, the wearable device 102 transmits the proper headers, control frames, data frames, and the like to establish a connection with the base station 104 and transmit packets to the base station 104.

The base station 104 may then analyze signals across a broadband, determine signal strength for certain frequencies, and then provide the signal strengths to a server 108 over the transmission medium 106. The server 108 may then act on the signal strength data received from the base station 104.

Although only one base station 104 is described in FIG. 1, it is understood that in practice, there may be multiple base stations around the arena, each capturing user feedback in a geographical area. Results (e.g., signal strength readings) from the multiple base stations 104, may be combined to generate an overall result.

Signal strength refers to the magnitude of the electric field and may be referred to as a received signal level or field strength. In IEEE 802.11 implementations, signal strength may be measured using a received signal strength indicator (RSSI). RSSI is a relative received signal strength in arbitrary units. RSSI is an indication of the power level being received by an antenna. As such, the higher RSSI number, the stronger the signal. Related to RSSI is received channel power indicator (RCPI). Where RSSI only samples during the preamble stage of receiving an 802.11 frame, the RCPI measures the received radio frequency (RF) power in a selected channel over the preamble and the entire received frame. Outside of IEEE 802.11 implementations, analogous measurements of signal strength may be measured and quantified by the base station 104.

When an event occurs in the environment 100, one or more users equipped with wearable devices 102 may react consciously or unconsciously. For example, when at a political rally and the speaker makes an emotional point, users may raise their arms to cheer. The wearable devices 102 may register the arm-raise gesture, select an RF frequency band based on a predetermined assignment between gesture and frequency band, and transmit a signal over the RF frequency band. Optionally, the signal may be formatted as a frame or packet according to a network protocol. Based on the response as gauged from the signal strengths of those in the audience, a presentation may be displayed on a public display 110. The presentation may be a message, a theme, a character, or some other dynamic presentation that adapts to the amount of feedback from the audience in real-time or near real-time.

Alternatively, one or more users equipped with wearable devices 102 may not react to the speaker's point. The non-reaction, or non-movement gesture, may indicate a lack of interest in the presentation, or a disapproval of the subject matter in the presentation. Thus, the number of non-movement gestures may be tracked over time to determine whether a portion of an audience is exhibiting disapproval or disinterest through inaction.

As such, in various embodiments of the system, the system may track positive gestures. Lack of positive gestures over time may mean that the crowd is not enjoying themselves and thus having a negative experience. In a related embodiment, the system may track positive and negative gestures through tracking those who have wearable devices 102 and whether they show affirming gestures or non-gestures, respectively. Some negative gestures may be classified and recognized using special wearable devices 102, such as gloves, which are able to recognize certain finger-based gestures.

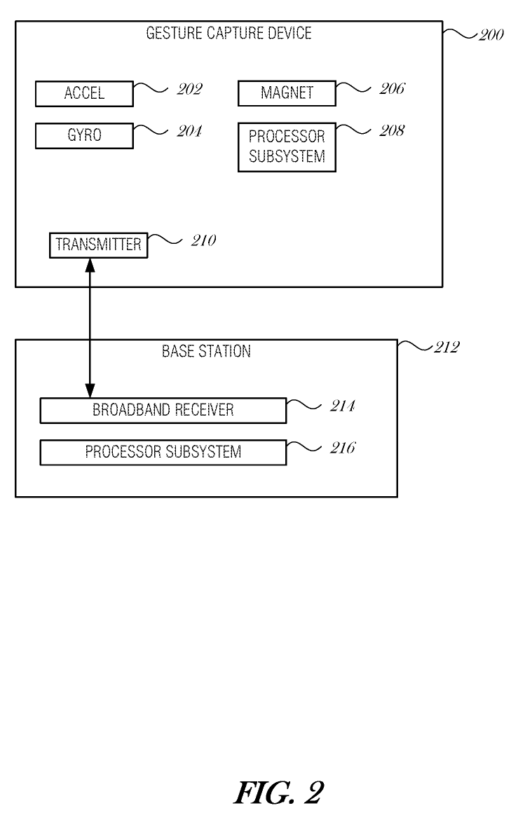

FIG. 2 is a block diagram illustrating a gesture capture device 200 and a base station 212, according to an embodiment. The gesture capture device 200 may be in the form of a wearable device (e.g., wearable device 102) or a mobile device (e.g., a smartphone, personal digital assistant, electronic baton, or the like). The gesture capture device 200 is capable of capturing motion data using an accelerometer 202, a gyrometer 204, and an optional magnetometer 206. The gesture capture device 200 includes a processor subsystem 208 that accesses motion data from the sensors 202, 204, 206 and performs classification. A classifier may be used to determine a gesture from the motion data. The processor subsystem 208 also accesses motion data from the sensors 202, 204, 206 that indicate the speed and force of the gesture performed. Using these parameters (gesture, speed, force), the processor subsystem 208 selects a transmit RF frequency band. A far-field transmitter 210 is then used to transmit a signal or signals over the transmit RF frequency band. The strength of the signal or signals is configured based on the speed and/or force of the gesture. The strength of the signal may be varied by increasing/decreasing the transmission wattage (e.g., in a range of 70 mW to 150 mW), increasing/decreasing the amount of data sent (e.g., in a range of 10 Mbs to 100 Mbs), or the like.

The gesture capture device 200 may be configured to work with a subset of frequencies, such as the 900 MHz band, the 2.4 GHz band, or a 5.2 GHz band. Such bands are attractive because they are unlicensed in many countries. Other bands may be used to conform to local laws and regulations. The gesture capture device 200 may include a software-defined radio (SDR) to transmit and receive a wide array of radio protocols based solely on the software configuration. Using an SDR may be advantageous for multi-country product rollouts.

The base station 212 includes a broadband receiver 214 capable of receiving signals over a wide range of RF frequencies. Similar to the gesture capture device 200, the broadband receiver 214 may be configured to work with a subset of frequencies, such as the 900 MHz band, the 2.4 GHz band, or a 5.2 GHz band. The broadband receiver 214 may be configured to work at same band as the gesture capture device 200. Alternatively, the broadband receiver 214 may scan a wide range of bands to determine whether a threshold signal strength is present in any of the channels of a particular band. A processor subsystem 216 on the base station 212 may use a Fast-Fourier Transform circuit or other mechanism to process the received signals and quantify them. Thus, the signal strength received by the base station 212 is representative of both the number of people performing a certain gesture and the intensity of such gestures.

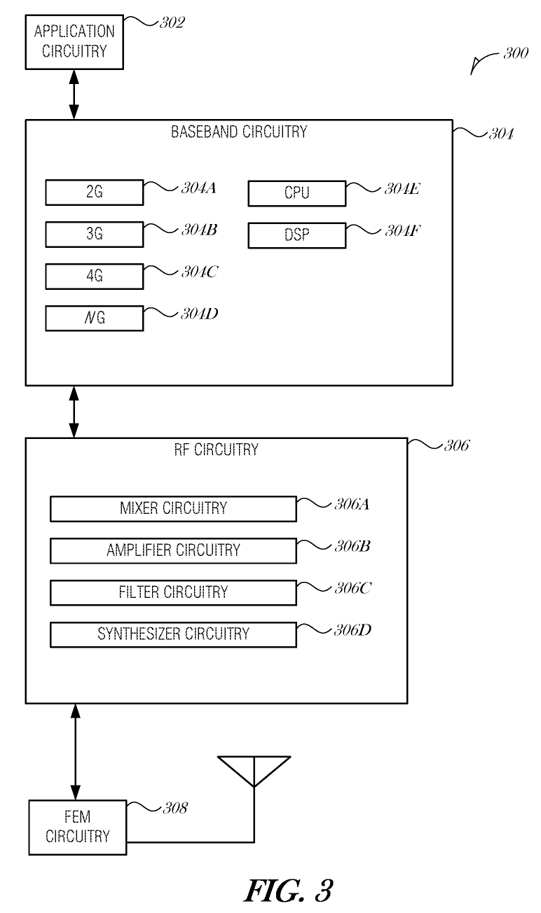

FIG. 3 is a block diagram of an example of a gesture capture device 300 upon which one or more embodiments may be implemented. In an example, the gesture capture device 300 may include application circuitry 302, baseband circuitry 304, radio frequency (RF) circuitry 306, front-end module (FEM) circuitry 308 and one or more antennas 310, coupled together at least as shown. As used with reference to FIG. 3, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

The application circuitry 302 may include one or more application processors. For example, the application circuitry 302 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 304 may include circuitry such as, but not limited to, one or more single-core or multi-core processors. The baseband circuitry 304 may include one or more baseband processors and/or control logic to process baseband signals received from a receive signal path of the RF circuitry 306 and to generate baseband signals for a transmit signal path of the RF circuitry 306. Baseband processing circuitry 304 may interface with the application circuitry 302 for generation and processing of the baseband signals and for controlling operations of the RF circuitry 306. For example, the baseband circuitry 304 may include a second generation (2G) baseband processor 304A, third generation (3G) baseband processor 304B, fourth generation (4G) baseband processor 304C, and/or other baseband processor(s) 304D for other existing generations, generations in development or to be developed in the future (e.g., fifth generation (5G), 6G, etc.). The baseband circuitry 304 (e.g., one or more of baseband processors 304A-D) may handle various radio control functions that enable communication with one or more radio networks via the RF circuitry 306. The radio control functions may include, but are not limited to, signal modulation/demodulation, encoding/decoding, radio frequency shifting, etc. In an example, modulation/demodulation circuitry of the baseband circuitry 304 may include Fast-Fourier Transform (FFT), preceding, and/or constellation mapping/demapping functionality. In an example, encoding/decoding circuitry of the baseband circuitry 304 may include convolution, tail-biting convolution, turbo, Viterbi, and/or Low Density Parity Check (LDPC) encoder/decoder functionality Embodiments of modulation/demodulation and encoder/decoder functionality are not limited to these examples and may include other suitable functionality in other embodiments.

In an example, the baseband circuitry 304 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 304E of the baseband circuitry 304 may be configured to run elements of the protocol stack for signaling of the PHY, MAC, RLC, PDCP and/or RRC layers. In an example, the baseband circuitry may include one or more audio digital signal processor(s) (DSP) 304F. The audio DSP(s) 304F may be include elements for compression/decompression and echo cancellation and may include other suitable processing elements in other embodiments. In an example, components of the baseband circuitry may be suitably combined in a single chip, a single chipset, or disposed on a same circuit board. In an example, some or all of the constituent components of the baseband circuitry 304 and the application circuitry 302 may be implemented together such as, for example, on a system on a chip (SOC).

In an example, the baseband circuitry 304 may provide for communication compatible with one or more radio technologies. For example, the baseband circuitry 304 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 304 is configured to support radio communications of more than one wireless protocol may be referred to as multi-mode baseband circuitry.

RF circuitry 306 may enable communication with wireless networks using modulated electromagnetic radiation through a non-solid medium. In various embodiments, the RF circuitry 306 may include switches, filters, amplifiers, etc. to facilitate the communication with the wireless network. RF circuitry 306 may include a receive signal path which may include circuitry to down-convert RF signals received from the FEM circuitry 308 and provide baseband signals to the baseband circuitry 304. RF circuitry 306 may also include a transmit signal path which may include circuitry to up-convert baseband signals provided by the baseband circuitry 304 and provide RF output signals to the FEM circuitry 308 for transmission.

In an example, the RF circuitry 306 may include a receive signal path and a transmit signal path. The receive signal path of the RF circuitry 306 may include mixer circuitry 306A, amplifier circuitry 306B and filter circuitry 306C. The transmit signal path of the RF circuitry 306 may include filter circuitry 306C and mixer circuitry 306A. RF circuitry 306 may also include synthesizer circuitry 306D for synthesizing a frequency for use by the mixer circuitry 306A of the receive signal path and the transmit signal path. In an example, the mixer circuitry 306A of the receive signal path may be configured to down-convert RF signals received from the FEM circuitry 308 based on the synthesized frequency provided by synthesizer circuitry 306D. The amplifier circuitry 306B may be configured to amplify the down-converted signals and the filter circuitry 306C may be a low-pass filter (LPF) or band-pass filter (BPF) configured to remove unwanted signals from the down-converted signals to generate output baseband signals. Output baseband signals may be provided to the baseband circuitry 304 for further processing. In an example, the output baseband signals may be zero-frequency baseband signals, although this is not a requirement. In an example, mixer circuitry 306A of the receive signal path may comprise passive mixers, although the scope of the embodiments is not limited in this respect.

In an example, the mixer circuitry 306A of the transmit signal path may be configured to up-convert input baseband signals based on the synthesized frequency provided by the synthesizer circuitry 306D to generate RF output signals for the FEM circuitry 308. The baseband signals may be provided by the baseband circuitry 304 and may be filtered by filter circuitry 306C. The filter circuitry 306C may include a low-pass filter (LPF), although the scope of the embodiments is not limited in this respect.

In an example, the mixer circuitry 306A of the receive signal path and the mixer circuitry 306A of the transmit signal path may include two or more mixers and may be arranged for quadrature downconversion and/or upconversion respectively. In an example, the mixer circuitry 306A of the receive signal path and the mixer circuitry 306A of the transmit signal path may include two or more mixers and may be arranged for image rejection (e.g., Hartley image rejection). In an example, the mixer circuitry 306A of the receive signal path and the mixer circuitry 306a may be arranged for direct downconversion and/or direct upconversion, respectively. In an example, the mixer circuitry 306a of the receive signal path and the mixer circuitry 306a of the transmit signal path may be configured for super-heterodyne operation.

In an example, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 306 may include analog-to-digital converter (ADC) and digital-to-analog converter (DAC) circuitry and the baseband circuitry 304 may include a digital baseband interface to communicate with the RF circuitry 306.

In a dual-mode example, a separate radio IC circuitry may be provided for processing signals for each spectrum, although the scope of the embodiments is not limited in this respect.

In an example, the synthesizer circuitry 306d may be a fractional-N synthesizer or a fractional N/N+1 synthesizer, although the scope of the embodiments is not limited in this respect as other types of frequency synthesizers may be suitable. For example, synthesizer circuitry 306d may be a delta-sigma synthesizer, a frequency multiplier, or a synthesizer comprising a phase-locked loop with a frequency divider.

The synthesizer circuitry 306d may be configured to synthesize an output frequency for use by the mixer circuitry 306a of the RF circuitry 306 based on a frequency input and a divider control input. In an example, the synthesizer circuitry 306d may be a fractional N/N+1 synthesizer.

In an example, frequency input may be provided by a voltage controlled oscillator (VCO), although that is not a requirement. Divider control input may be provided by either the baseband circuitry 304 or the applications processor 302 depending on the desired output frequency. In an example, a divider control input (e.g., N) may be determined from a look-up table based on a channel indicated by the applications processor 302.

Synthesizer circuitry 306D of the RF circuitry 306 may include a divider, a delay-locked loop (DLL), a multiplexer and a phase accumulator. In an example, the divider may be a dual modulus divider (DMD) and the phase accumulator may be a digital phase accumulator (DPA). In an example, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In an example, synthesizer circuitry 306D may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In an example, the output frequency may be a LO frequency (fLO). In an example, the RF circuitry 306 may include an IQ/polar converter.

FEM circuitry 308 may include a receive signal path which may include circuitry configured to operate on RF signals received from one or more antennas 310, amplify the received signals and provide the amplified versions of the received signals to the RF circuitry 306 for further processing. FEM circuitry 308 may also include a transmit signal path which may include circuitry configured to amplify signals for transmission provided by the RF circuitry 306 for transmission by one or more of the one or more antennas 310.

In an example, the FEM circuitry 308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 306). The transmit signal path of the FEM circuitry 308 may include a power amplifier (PA) to amplify input RF signals (e.g., provided by RF circuitry 306), and one or more filters to generate RF signals for subsequent transmission (e.g., by one or more of the one or more antennas 310.

In an example, the gesture capture device 300 may include additional elements such as, for example, memory/storage, display, camera, sensor, and/or input/output (I/O) interface.

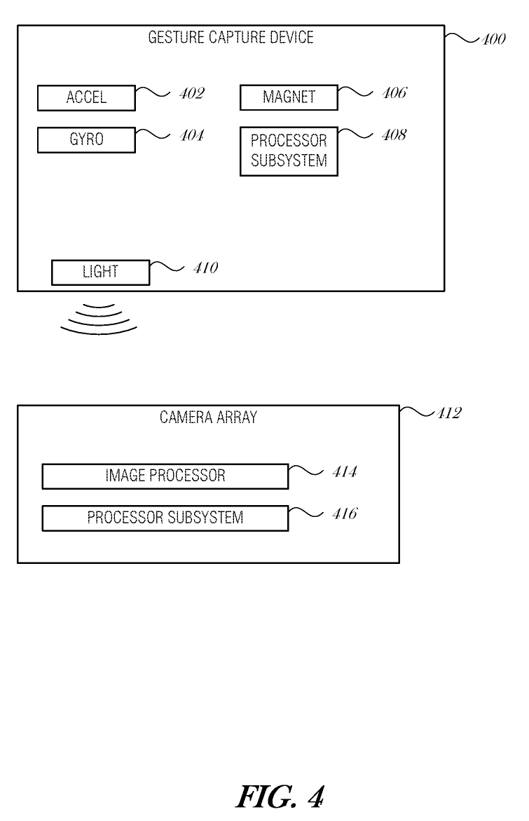

FIG. 4 is block diagram illustrating another gesture capture device 400 and a camera array 412, according to an embodiment. As with the gesture capture device 200, the gesture capture device 400 may be in the form of a wearable device (e.g., wearable device 102) or a mobile device (e.g., a smartphone, personal digital assistant, electronic baton, or the like). The gesture capture device 400 is capable of capturing motion data using an accelerometer 402, a gyrometer 404, and an optional magnetometer 406. The gesture capture device 400 includes a processor subsystem 408 that accesses motion data from the sensors 402, 404, 406 and performs classification. A classifier may be used to determine a gesture from the motion data. The processor subsystem 408 also accesses motion data from the sensors 402, 404, 406 that indicate the speed and force of the gesture performed. Instead of selecting a transmission RF frequency band (as in FIG. 2), the processor subsystem 408 uses these parameters (gesture, speed, force) to determine a light color and a light intensity. As used herein, “light” refers to electromagnetic radiation with a wavelength between approximately 400 and approximately 700 nanometers. The gesture capture device 400 may dynamically illuminate one or more lights 410 in response to the color and intensity settings. In an example, the gesture capture device 400 includes one lamp and the color and intensity are adjusted for the single light. In another example, the gesture capture device 400 includes multiple lights, and the intensity is adjusted, at least in part, by illuminating or damping one or more of the lights. The lights 410 may be any type of light mechanism, such as a light-emitting diode (LED), organic LED, liquid crystal display (LCD), or the like. To produce multiple various colors, several LEDs (or other lighting elements) may be incorporated into a single housing and be referred to as a single light. For example, a red, green, and blue LED may be housed together and dynamically activated to produce a wide range of colors.

The camera array 412 includes an image processor 414 capable of processing images or video of an audience having gesture capture devices 400 emitting light. The image processor 414 may work in conjunction with a processor subsystem 416, or independently, to determine a color being emitted by lights on gesture capture devices 400 and the luminous intensity as measured by foot-candles, candlepower, candela, etc., of the lights.

The camera array 412 may include one or more optical cameras, infrared cameras, depth cameras, or the combinations thereof to detect gestures, light emitted from gesture capture devices 400, or other aspects of the environment. Using one or more video frames and image analysis, the camera array 412 may classify motion of one or more people as being a gesture. The camera array 412 may use visible light video, infrared, depth video, or combinations of images to identify motion of people, then classify the motion as a gesture.

Use of light to indicate crowd reaction may be limited to certain environments where ambient light does not overwhelm the light from gesture capture devices 400. Thus, light-based embodiments may be used selectively at night, indoors, or in other environments where the light from the devices is observable and distinguishable.

Thus, using devices described in FIGS. 1-4, a versatile system is provided that may be used to perform a variety of event functions. The data may be collected in real time and nearly continuously. The crowd does not need to be prompted to perform motions in response to a poll question. Rather, their natural responses may be captured and used for scoring, feedback, audience participation, and the like. Crowd games may be created on the fly. For example, a gesture may be designated for each of two riders at a race. Fans may score the riders as they desire. As another example, two teams as a football game may each be assigned a specific gesture at the start of the game. Fans may show their support by using the gesture throughout the game. At certain times during the game, the fan support may be measured (either after a prompt or just spontaneously) and the mascot of the team that has more fan support may dance on the field, or a fight song of the more active fans may be played over the public address system.

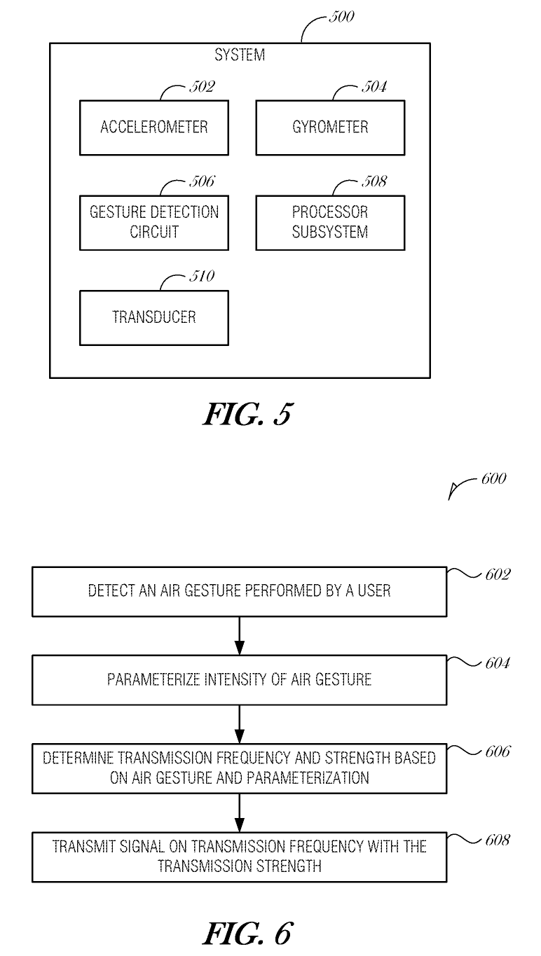

FIG. 5 is a block diagram illustrating system 500 for implementing crowd gesture recognition, according to an embodiment. The system 500 may include an accelerometer 502, a gyrometer 504, a gesture detection circuit 506, a processor subsystem 508, and a transducer 510.

The gesture detection circuit 506 may be configured to detect an air gesture performed by a user of the system based on data from the accelerometer 502 and gyrometer 504. Gesture detection may be based on a classifier that uses a machine learning technique to classify motion data into a gesture.

An “air gesture” is a movement in free space by a person moving their arm, hands, fingers, or some combination of these on one or both arms. The air gesture may also be performed with ones legs, or combinations of arms, body, and legs. The term air gesture is used to distinguish such gestures from gestures that are performed on a touchscreen (e.g., pinch and zoom gestures). In an embodiment, the air gesture comprises raising an arm in the air. In an embodiment, the air gesture comprises clapping hands.

The gesture detection circuit 506 may be further configured to parameterize an intensity of the air gesture. Parameterization includes analyzing the air gesture in the time domain to determine a number of instances of the gesture were performed in a given period. Parameterization may also include analyzing the air gesture in the space domain to determine the magnitude of the gesture (e.g., a large waving of the hands versus a smaller waving).

In an embodiment, to parameterize the intensity of the air gesture, the gesture detection circuit 506 is to determine a speed or an acceleration of the air gesture.

In an embodiment, to parameterize the intensity of the air gesture, the gesture detection circuit 506 is to determine a number of times the air gesture was performed in a period. The period may be relative short, such as one second or relatively long, such as ten seconds. For example, the number of claps performed in a five second period may be determined and the parameter of five is used to describe the intensity. The intensity may be relative to a predetermined range of claps per second.

The processor subsystem 508 may be configured to determine a transmission frequency band and a transmission strength based on the air gesture and the intensity of the air gesture. The processor subsystem 508 may be used to execute the instruction on the machine-readable medium. The processor subsystem 508 may include one or more processors, each with one or more cores. Additionally, the processor subsystem 508 may be disposed on one or more physical devices. The processor subsystem 508 may include one or more specialized processors, such as a graphics processing unit (GPU), a digital signal processor (DSP), a field programmable gate array (FPGA), or a fixed function processor.

In an embodiment, to determine the transmission frequency band and the transmission strength, the processor subsystem 508 is to perform a lookup on an association table, the association table including a set of gestures and a corresponding set of transmission frequencies. The association table may be uploaded to the system before or during an event (e.g., while a football game is being played). As such, using the association table, the recognized gestures and the frequencies that they map to may be dynamically altered throughout an event.

In an embodiment, to determine the transmission frequency band and the transmission strength, the processor subsystem 508 is to scale the transmission strength over a range based on the intensity of the air gesture. The range may be based on empirical data of gesture magnitudes for different gestures. For example, when clapping, a slow clap may be set as being approximately one clap per second, whereas a fast clap may be set as approximately ten claps per second. A minimum transmission strength may be set to a minimum practical transmission strength to carry the signal from the transmitting transducer to a receiver radio. The minimum transmission strength may have some error built in to ensure that signals may be received. The maximum transmission strength may be based on available battery, radio capabilities, and the like. Once the minimum and maximum transmission strengths and gesture intensities are understood, a one-to-one mapping may be determined and used for scaling.

The transducer 510 may be configured to transmit a signal on the transmission frequency band with the transmission strength. In general, a transducer 510 is an electronic device that converts energy from one form to another. In the case where the system is transmitting a wireless networking signal, the output energy is a high-frequency RF signal. In the case where the system is illuminating a light, the output energy is a low-frequency visible light signal.

In an embodiment, to transmit the signal on the transmission frequency band with the transmission strength, the transducer 510 is to transmit a raw tone at the transmission frequency band. In an embodiment, to transmit the signal on the transmission frequency band with the transmission strength, the transducer 510 is to transmit a packet using a network protocol at the transmission frequency band. The packet may be a Wi-Fi frame, for example. Other protocols such as Bluetooth, ZigBee, and the like may also be used. In an embodiment, to transmit the signal on the transmission frequency band with the transmission strength, the transducer 510 is to illuminate a light of the user device at a color correlated to the transmission frequency band. The light may be provided by one or more LED, LCD, OLED, etc. lamps.

In an embodiment, to transmit the signal on the transmission frequency band with the transmission strength, the transducer 510 is to illuminate a light of the user device at a luminous intensity correlated to the transmission strength. Luminous intensity may be scaled to the transmission strength based on a minimum and maximum available intensity of the lamps in the system 500.

In an embodiment, the signal is transmitted to a receiver device, the receiver device to detect and aggregate received signals based on transmission frequencies and signal strengths. In a further embodiment, a responsive action is performed based on the detected and aggregated received signals. The responsive action may be any of a wide variety of actions, such as increasing/decreasing the volume of an jazz band based on how many people are clapping along, altering a shared stadium display based on audience participation, or the like.

In an embodiment, the system 500 is a wearable device, such as a smart ring, a smart bracelet, a smartwatch, etc. In an embodiment, the system 500 is a handheld device, such as a mobile phone or an electronic baton.

FIG. 6 is a flowchart illustrating a method 600 of implementing crowd gesture recognition, according to an embodiment. At block 602, an air gesture performed by a user of a user device is detected by the user device. In an embodiment, the air gesture comprises raising an arm in the air. In an embodiment, the air gesture comprises clapping hands. In an embodiment, the user device is a wearable device. In an embodiment, the user device is a handheld device.

At block 604, an intensity of the air gesture is parameterized. In an embodiment, parameterizing the intensity of the air gesture comprises determining a speed or an acceleration of the air gesture. In an embodiment, parameterizing the intensity of the air gesture comprises determining a number of times the air gesture was performed in a period.

At block 606, a transmission frequency band and a transmission strength is determined based on the air gesture and the intensity of the air gesture. In an embodiment, determining the transmission frequency band and the transmission strength comprises performing a lookup on an association table, the association table including a set of gestures and a corresponding set of transmission frequencies. In an embodiment, determining the transmission frequency band and the transmission strength comprises scaling the transmission strength over a range based on the intensity of the air gesture.

At block 608, a signal is transmitted on the transmission frequency band with the transmission strength. In an embodiment, transmitting the signal on the transmission frequency band with the transmission strength comprises transmitting a raw tone at the transmission frequency band.

In an embodiment, transmitting the signal on the transmission frequency band with the transmission strength comprises transmitting a packet using a network protocol at the transmission frequency band.

In an embodiment, transmitting the signal on the transmission frequency band with the transmission strength comprises illuminating a light of the user device at a color correlated to the transmission frequency band.

In an embodiment, transmitting the signal on the transmission frequency band with the transmission strength comprises illuminating a light of the user device at a luminous intensity correlated to the transmission strength.

In an embodiment, the method 600 includes wherein the signal is transmitted to a receiver device, the receiver device to detect and aggregate received signals based on transmission frequencies and signal strengths. In a further embodiment, a responsive action is performed based on the detected and aggregated received signals.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

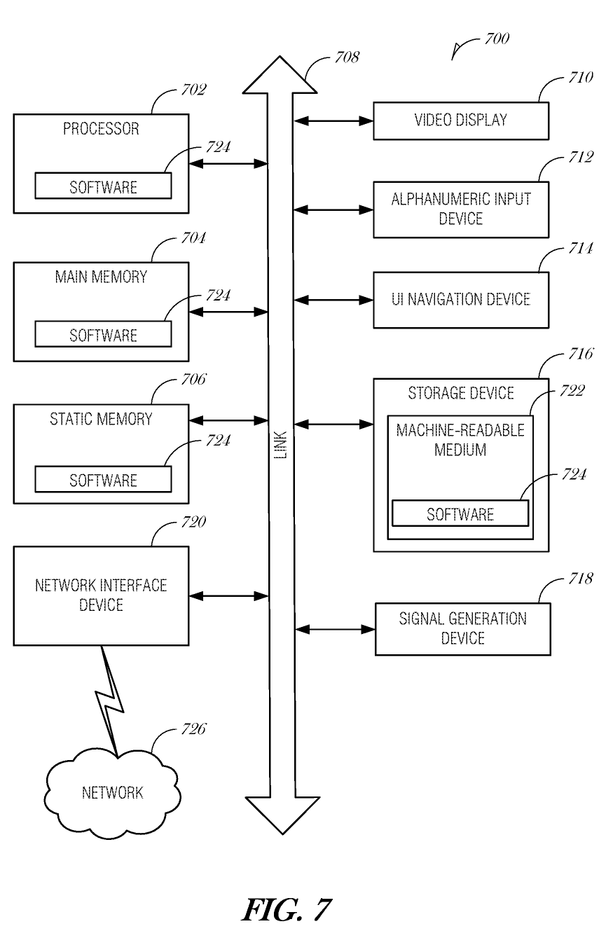

FIG. 7 is a block diagram illustrating a machine in the example form of a computer system 700, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is a system for implementing crowd gesture recognition, the system comprising: an accelerometer; a gyrometer; a gesture detection circuit to: detect an air gesture performed by a user of the system based on data from the accelerometer and gyrometer; and parameterize an intensity of the air gesture; a processor subsystem to determine a transmission frequency band and a transmission strength based on the air gesture and the intensity of the air gesture; and a transducer to transmit a signal on the transmission frequency band with the transmission strength.

In Example 2, the subject matter of Example 1 optionally includes, wherein the air gesture comprises raising an arm in the air.

In Example 3, the subject matter of any one or more of Examples 1-2 optionally include, wherein the air gesture comprises clapping hands.

In Example 4, the subject matter of any one or more of Examples 1-3 optionally include, wherein the air gesture comprises a non-movement gesture.

In Example 5, the subject matter of any one or more of Examples 1-4 optionally include, wherein to parameterize the intensity of the air gesture, the gesture detection circuit is to determine a speed or an acceleration of the air gesture.

In Example 6, the subject matter of any one or more of Examples 1-5 optionally include, wherein to parameterize the intensity of the air gesture, the gesture detection circuit is to determine a number of times the air gesture was performed in a period.

In Example 7, the subject matter of any one or more of Examples 1-6 optionally include, wherein to determine the transmission frequency band and the transmission strength, the processor subsystem is to perform a lookup on an association table, the association table including a set of gestures and a corresponding set of transmission frequencies.

In Example 8, the subject matter of any one or more of Examples 1-7 optionally include, wherein to determine the transmission frequency band and the transmission strength, the processor subsystem is to scale the transmission strength over a range based on the intensity of the air gesture.

In Example 9, the subject matter of any one or more of Examples 1-8 optionally include, wherein to transmit the signal on the transmission frequency band with the transmission strength, the transducer is to transmit a raw tone at the transmission frequency band.

In Example 10, the subject matter of any one or more of Examples 1-9 optionally include, wherein to transmit the signal on the transmission frequency band with the transmission strength, the transducer is to transmit a packet using a network protocol at the transmission frequency band.

In Example 11, the subject matter of any one or more of Examples 1-10 optionally include, wherein to transmit the signal on the transmission frequency band with the transmission strength, the transducer is to illuminate a light of the user device at a color correlated to the transmission frequency band.

In Example 12, the subject matter of any one or more of Examples 1-11 optionally include, wherein to transmit the signal on the transmission frequency band with the transmission strength, the transducer is to illuminate a light of the user device at a luminous intensity correlated to the transmission strength.

In Example 13, the subject matter of any one or more of Examples 1-12 optionally include, wherein the signal is transmitted to a receiver device, the receiver device to detect and aggregate received signals based on transmission frequencies and signal strengths.

In Example 14, the subject matter of Example 13 optionally includes, wherein a responsive action is performed based on the detected and aggregated received signals.

In Example 15, the subject matter of any one or more of Examples 1-14 optionally include, wherein the system is a wearable device.

In Example 16, the subject matter of any one or more of Examples 1-15 optionally include, wherein the system is a handheld device.

Example 17 is a method of implementing crowd gesture recognition, the method comprising: detecting, at a user device, an air gesture performed by a user of the user device; parameterizing an intensity of the air gesture; determining a transmission frequency band and a transmission strength based on the air gesture and the intensity of the air gesture; and transmitting a signal on the transmission frequency band with the transmission strength.

In Example 18, the subject matter of Example 17 optionally includes, wherein the air gesture comprises raising an arm in the air.

In Example 19, the subject matter of any one or more of Examples 17-18 optionally include, wherein the air gesture comprises clapping hands.

In Example 20, the subject matter of any one or more of Examples 17-19 optionally include, wherein the air gesture comprises a non-movement gesture.

In Example 21, the subject matter of any one or more of Examples 17-20 optionally include, wherein parameterizing the intensity of the air gesture comprises determining a speed or an acceleration of the air gesture.

In Example 22, the subject matter of any one or more of Examples 17-21 optionally include, wherein parameterizing the intensity of the air gesture comprises determining a number of times the air gesture was performed in a period.

In Example 23, the subject matter of any one or more of Examples 17-22 optionally include, wherein determining the transmission frequency band and the transmission strength comprises performing a lookup on an association table, the association table including a set of gestures and a corresponding set of transmission frequencies.

In Example 24, the subject matter of any one or more of Examples 17-23 optionally include, wherein determining the transmission frequency band and the transmission strength comprises scaling the transmission strength over a range based on the intensity of the air gesture.

In Example 25, the subject matter of any one or more of Examples 17-24 optionally include, wherein transmitting the signal on the transmission frequency band with the transmission strength comprises transmitting a raw tone at the transmission frequency band.

In Example 26, the subject matter of any one or more of Examples 17-25 optionally include, wherein transmitting the signal on the transmission frequency band with the transmission strength comprises transmitting a packet using a network protocol at the transmission frequency band.

In Example 27, the subject matter of any one or more of Examples 17-26 optionally include, wherein transmitting the signal on the transmission frequency band with the transmission strength comprises: illuminating a light of the user device at a color correlated to the transmission frequency band.

In Example 28, the subject matter of any one or more of Examples 17-27 optionally include, wherein transmitting the signal on the transmission frequency band with the transmission strength comprises illuminating a light of the user device at a luminous intensity correlated to the transmission strength.

In Example 29, the subject matter of any one or more of Examples 17-28 optionally include, wherein the signal is transmitted to a receiver device, the receiver device to detect and aggregate received signals based on transmission frequencies and signal strengths.

In Example 30, the subject matter of Example 29 optionally includes, wherein a responsive action is performed based on the detected and aggregated received signals.

In Example 31, the subject matter of any one or more of Examples 17-30 optionally include, wherein the user device is a wearable device.

In Example 32, the subject matter of any one or more of Examples 17-31 optionally include, wherein the user device is a handheld device.

Example 33 is at least one machine-readable medium including instructions, which when executed by a machine, cause the machine to perform operations of any of the methods of Examples 17-32.

Example 34 is an apparatus comprising means for performing any of the methods of Examples 17-32.

Example 35 is an apparatus for implementing crowd gesture recognition, the apparatus comprising: means for detecting, at a user device, an air gesture performed by a user of the user device; means for parameterizing an intensity of the air gesture; means for determining a transmission frequency band and a transmission strength based on the air gesture and the intensity of the air gesture; and means for transmitting a signal on the transmission frequency band with the transmission strength.

In Example 36, the subject matter of Example 35 optionally includes, wherein the air gesture comprises raising an arm in the air.

In Example 37, the subject matter of any one or more of Examples 35-36 optionally include, wherein the air gesture comprises clapping hands.

In Example 38, the subject matter of any one or more of Examples 35-37 optionally include, wherein the air gesture comprises a non-movement gesture.

In Example 39, the subject matter of any one or more of Examples 35-38 optionally include, wherein the means for parameterizing the intensity of the air gesture comprise means for determining a speed or an acceleration of the air gesture.

In Example 40, the subject matter of any one or more of Examples 35-39 optionally include, wherein the means for parameterizing the intensity of the air gesture comprise means for determining a number of times the air gesture was performed in a period.

In Example 41, the subject matter of any one or more of Examples 35-40 optionally include, wherein the means for determining the transmission frequency band and the transmission strength comprise means for performing a lookup on an association table, the association table including a set of gestures and a corresponding set of transmission frequencies.

In Example 42, the subject matter of any one or more of Examples 35-41 optionally include, wherein the means for determining the transmission frequency band and the transmission strength comprise means for scaling the transmission strength over a range based on the intensity of the air gesture.

In Example 43, the subject matter of any one or more of Examples 35-42 optionally include, wherein the means for transmitting the signal on the transmission frequency band with the transmission strength comprise means for transmitting a raw tone at the transmission frequency band.

In Example 44, the subject matter of any one or more of Examples 35-43 optionally include, wherein the means for transmitting the signal on the transmission frequency band with the transmission strength comprise means for transmitting a packet using a network protocol at the transmission frequency band.

In Example 45, the subject matter of any one or more of Examples 35-44 optionally include, wherein the means for transmitting the signal on the transmission frequency band with the transmission strength comprise means for illuminating a light of the user device at a color correlated to the transmission frequency band.

In Example 46, the subject matter of any one or more of Examples 35-45 optionally include, wherein the means for transmitting the signal on the transmission frequency band with the transmission strength comprise means for illuminating a light of the user device at a luminous intensity correlated to the transmission strength.

In Example 47, the subject matter of any one or more of Examples 35-46 optionally include, wherein the signal is transmitted to a receiver device, the receiver device to detect and aggregate received signals based on transmission frequencies and signal strengths.

In Example 48, the subject matter of Example 47 optionally includes, wherein a responsive action is performed based on the detected and aggregated received signals.

In Example 49, the subject matter of any one or more of Examples 35-48 optionally include, wherein the user device is a wearable device.

In Example 50, the subject matter of any one or more of Examples 35-49 optionally include, wherein the user device is a handheld device.

Example 51 is a system for implementing crowd gesture recognition, the system comprising: a processor subsystem; and a memory including instructions, which when executed by the processor subsystem, cause the processor subsystem to: detect, at a user device, an air gesture performed by a user of the user device; parameterize an intensity of the air gesture; determine a transmission frequency band and a transmission strength based on the air gesture and the intensity of the air gesture; and transmit a signal on the transmission frequency band with the transmission strength.

In Example 52, the subject matter of Example 51 optionally includes, wherein the air gesture comprises raising an arm in the air.

In Example 53, the subject matter of any one or more of Examples 51-52 optionally include, wherein the air gesture comprises clapping hands.

In Example 54, the subject matter of any one or more of Examples 51-53 optionally include, wherein the air gesture comprises a non-movement gesture.

In Example 55, the subject matter of any one or more of Examples 51-54 optionally include, wherein the instructions to parameterize the intensity of the air gesture comprise instructions to determine a speed or an acceleration of the air gesture.

In Example 56, the subject matter of any one or more of Examples 51-55 optionally include, wherein the instructions to parameterize the intensity of the air gesture comprise instructions to determine a number of times the air gesture was performed in a period.

In Example 57, the subject matter of any one or more of Examples 51-56 optionally include, wherein the instructions to determine the transmission frequency band and the transmission strength comprise instructions to perform a lookup on an association table, the association table including a set of gestures and a corresponding set of transmission frequencies.

In Example 58, the subject matter of any one or more of Examples 51-57 optionally include, wherein the instructions to determine the transmission frequency band and the transmission strength comprise instructions to scale the transmission strength over a range based on the intensity of the air gesture.

In Example 59, the subject matter of any one or more of Examples 51-58 optionally include, wherein the instructions to transmit the signal on the transmission frequency band with the transmission strength comprise instructions to transmit a raw tone at the transmission frequency band.

In Example 60, the subject matter of any one or more of Examples 51-59 optionally include, wherein the instructions to transmit the signal on the transmission frequency band with the transmission strength comprise instructions to transmit a packet using a network protocol at the transmission frequency band.

In Example 61, the subject matter of any one or more of Examples 51-60 optionally include, wherein the instructions to transmit the signal on the transmission frequency band with the transmission strength comprise instructions to illuminate a light of the user device at a color correlated to the transmission frequency band.

In Example 62, the subject matter of any one or more of Examples 51-61 optionally include, wherein the instructions to transmit the signal on the transmission frequency band with the transmission strength comprise instructions to illuminate a light of the user device at a luminous intensity correlated to the transmission strength.

In Example 63, the subject matter of any one or more of Examples 51-62 optionally include, wherein the signal is transmitted to a receiver device, the receiver device to detect and aggregate received signals based on transmission frequencies and signal strengths.

In Example 64, the subject matter of Example 63 optionally includes, wherein a responsive action is performed based on the detected and aggregated received signals.

In Example 65, the subject matter of any one or more of Examples 51-64 optionally include, wherein the user device is a wearable device.

In Example 66, the subject matter of any one or more of Examples 51-65 optionally include, wherein the user device is a handheld device.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for implementing crowd gesture recognition, the system comprising:
an accelerometer;
a gyrometer;
a gesture detection circuit to:
detect an air gesture performed by a user of the system based on data from the accelerometer and gyrometer; and
parameterize an intensity of the air gesture;
a processor subsystem to determine a transmission frequency band and a transmission strength based on the air gesture and the intensity of the air gesture; and
a transducer to transmit a signal on the transmission frequency band with the transmission strength.

2. The system of claim 1, wherein the air gesture comprises a non-movement gesture.

3. The system of claim 1, wherein the air gesture comprises clapping hands.

4. The system of claim 1, wherein to parameterize the intensity of the air gesture, the gesture detection circuit is to determine a speed or an acceleration of the air gesture.

5. The system of claim 1, wherein to parameterize the intensity of the air gesture, the gesture detection circuit is to determine a number of times the air gesture was performed in a period.

6. The system of claim 1, wherein to determine the transmission frequency band and the transmission strength, the processor subsystem is to perform a lookup on an association table, the association table including a set of gestures and a corresponding set of transmission frequencies.

7. The system of claim 1, wherein to determine the transmission frequency band and the transmission strength, the processor subsystem is to scale the transmission strength over a range based on the intensity of the air gesture.

8. The system of claim 1, wherein to transmit the signal on the transmission frequency band with the transmission strength, the transducer is to transmit a raw tone at the transmission frequency band.

9. The system of claim 1, wherein to transmit the signal on the transmission frequency band with the transmission strength, the transducer is to transmit a packet using a network protocol at the transmission frequency band.

10. The system of claim 1, wherein to transmit the signal on the transmission frequency band with the transmission strength, the transducer is to illuminate a light of the user device at a color correlated to the transmission frequency band.

11. The system of claim 1, wherein to transmit the signal on the transmission frequency band with the transmission strength, the transducer is to illuminate a light of the user device at a luminous intensity correlated to the transmission strength.

12. The system of claim 1, wherein the signal is transmitted to a receiver device, the receiver device to detect and aggregate received signals based on transmission frequencies and signal strengths.

13. The system of claim 12, wherein a responsive action is performed based on the detected and aggregated received signals.

14. The system of claim 1, wherein the system is a wearable device.

15. The system of claim 1, wherein the system is a handheld device.

16. A method of implementing crowd gesture recognition, the method comprising:
detecting, at a user device, an air gesture performed by a user of the user device;
parameterizing an intensity of the air gesture;
determining a transmission frequency band and a transmission strength based on the air gesture and the intensity of the air gesture; and
transmitting a signal on the transmission frequency band with the transmission strength.

17. The method of claim 16, wherein determining the transmission frequency band and the transmission strength comprises performing a lookup on an association table, the association table including a set of gestures and a corresponding set of transmission frequencies.

18. The method of claim 16, wherein determining the transmission frequency band and the transmission strength comprises scaling the transmission strength over a range based on the intensity of the air gesture.

19. The method of claim 16, wherein transmitting the signal on the transmission frequency band with the transmission strength comprises transmitting a raw tone at the transmission frequency band.

20. The method of claim 16, wherein transmitting the signal on the transmission frequency band with the transmission strength comprises transmitting a packet using a network protocol at the transmission frequency band.

21. The method of claim 16, wherein transmitting the signal on the transmission frequency band with the transmission strength comprises:
illuminating a light of the user device at a color correlated to the transmission frequency band.

22. The method of claim 16, wherein transmitting the signal on the transmission frequency band with the transmission strength comprises illuminating a light of the user device at a luminous intensity correlated to the transmission strength.

23. At least one machine-readable medium including instructions, which when executed by a machine, cause the machine to:
detect, at a user device, an air gesture performed by a user of the user device;
parameterize an intensity of the air gesture;
determine a transmission frequency band and a transmission strength based on the air gesture and the intensity of the air gesture; and
transmit a signal on the transmission frequency band with the transmission strength.

24. The at least one machine-readable medium of claim 23, wherein the instructions to determine the transmission frequency band and the transmission strength comprise instructions to perform a lookup on an association table, the association table including a set of gestures and a corresponding set of transmission frequencies.

25. The at least one machine-readable medium of claim 23, wherein the instructions to determine the transmission frequency band and the transmission strength comprise instructions to scale the transmission strength over a range based on the intensity of the air gesture.
